(19) United States
(12) Patent Application Publication
(10) Pub. No.: US 2023/0162650 A1
(43) Pub. Date: May 25, 2023

(54) DISPLAY PANEL, MANUFACTURING METHOD THEREOF AND RELATED DISPLAY DEVICE

(71) Applicant: TCL China Star Optoelectronics Technology Co., Ltd., Shenzhen, Guangdong (CN)

(72) Inventors: Yun ZHANG, Shenzhen, Guangdong (CN); Xinhong CHEN, Shenzhen, Guangdong (CN)

(73) Assignee: TCL China Star Optoelectronics Technology Co., Ltd., Shenzhen, Guangdong (CN)

(21) Appl. No.: 17/427,160

(22) PCT Filed: May 27, 2021
(86) PCT No.: PCT/CN2021/096462

§ 371 Date: Jul. 30, 2021

(30) Foreign Application Priority Data
Feb. 24, 2021 (CN) 202110209539.8

(51) Int. Cl. G09G 3/20

(52) U.S. Cl. CPC G09G 3/2092; G09G 2320/0276; G09G 2320/0233

(57) ABSTRACT

A display panel driving method, a display device, and a driving device are provided. The method could determine an effective driving voltage value of a target pixel when the target display content is being displayed according to a standard gamma value, a standard driving voltage, and a driving voltage value of an interval endpoint and a corresponding mura removing parameter of a target driving voltage interval. A display panel is driven according to the effective driving voltage value of all the target pixels. This effectively alleviates the display inequality issue even if a common gamma value is applied.

### FIELD OF THE DISCLOSURE

The present disclosure relates to a display technology, and more particularly, to a display panel driving method, a display device and a driving device.

### BACKGROUND

The luminance equality is an important indication for evaluating the display effect of the display panel. The display panel may have all kinds of spots due to the luminance inequality and this reduces the display quality. This phenomenon caused by the luminance inequality is called “Mura.”

When the conventional display panel drives pixels to display an image, a common gamma value is used to provide corresponding driving voltages according to the required luminance values of the pixels. For example, when the pixels need to output the same luminance, the driver chip provides the same driving voltage to all the pixels. However, different pixels may have different reactions to the same voltages. For example, although the same driving voltage is provided, the driving voltage that actually applied on the pixels may be different because the resistances of the pixels and the connection wires are different. This makes different pixels output different luminance.

Therefore, a display inequality issue exists in the conventional display panel even if the common gamma value is applied.

### SUMMARY

### Technical Problem

One objective of an embodiment of the present disclosure is to provide a display panel driving method, a display device, and a driving device, to solve the above-mentioned display inequality issue when a common gamma value is applied.

### Technical Solution

According to an embodiment of the present disclosure, a display panel driving method is disclosed. The display panel driving method comprises: obtaining a standard driving voltage value of a target pixel when a target display content is being displayed according to a standard gamma value of a display panel; obtaining a driving voltage interval and an endpoint voltage value and an endpoint mura removing parameter of each driving voltage interval; obtaining a target driving voltage interval corresponding to the standard driving voltage value; determining an effective driving voltage value of the target pixel when the target display content is being displayed according to the standard gamma value, the standard driving voltage, and a driving voltage value of an interval endpoint and the corresponding mura removing parameter of a target driving voltage interval; and driving the display panel according to the effective driving voltage value of the target pixel.

Optionally, the step of determining an effective driving voltage value of the target pixel when the target display content is being displayed according to the standard gamma value, the standard driving voltage, and the driving voltage value of the interval endpoint and the corresponding mura removing parameter of the target driving voltage interval comprises: generating an endpoint curve value corresponding to the interval endpoint according to the standard gamma value and the driving voltage value of the interval endpoint; generating a standard curve value corresponding to the standard driving voltage value according to the standard gamma value and the standard driving voltage value; and determining the effective driving voltage value according to the standard curve value, the endpoint curve value and the mura removing parameter corresponding to the interval endpoint.

Optionally, the step of determining the effective driving voltage value according to the standard curve value, the endpoint curve value and the mura removing parameter corresponding to the interval endpoint comprises: determining the mura removing parameter corresponding to the target driving voltage value according to the standard curve value, the endpoint curve value and the mura removing parameter corresponding to the interval endpoint; and determining the effective driving voltage value according to the mura removing parameter corresponding to the target driving voltage value and the standard driving voltage value.

Optionally, the step of obtaining the standard gamma value comprises: obtaining a first luminance value corresponding to the driving voltage value of the interval endpoint and a second luminance value corresponding to a test voltage value of the display panel; determining a middle gamma value corresponding to each interval endpoint according to the driving voltage value of the interval endpoint, the test voltage value, the first luminance value and the second luminance value; and determining the standard gamma value according to the middle gamma value.

Optionally, the step of obtaining the endpoint mura removing parameter comprises: determining a reference curve of a driving voltage and a luminance of the display panel according to the second luminance value; and determining the endpoint mura removing parameter of each interval endpoint according to the first luminance value corresponding to each interval endpoint and the reference curve.

Optionally, the step of determining the endpoint mura removing parameter of each interval endpoint according to the first luminance value corresponding to each interval endpoint and the reference curve comprises:

determining a reference voltage value corresponding to each interval endpoint according to the reference curve and the first luminance value corresponding to each interval endpoint; and determining the endpoint mura removing parameter corresponding to each interval endpoint according to the reference voltage value and the driving voltage value corresponding to each interval endpoint.

Optionally, the step of determining the reference curve of the driving voltage and the luminance of the display panel according to the second luminance value comprises: obtaining a predetermined corresponding relationship between the driving voltage value and the luminance value; obtaining the second luminance value; and determining the reference curve of the driving voltage and the luminance of the display panel according to the second luminance value and the predetermined corresponding relationship between the driving voltage value and the luminance value.

Optionally, the step of driving the display panel according to the effective driving voltage value of the target pixel comprises: determining effective driving voltage values of non-target pixels according to the effective driving voltage values of all target pixels; and driving the display panel according to the effective driving voltage values of non-target pixels and the effective driving voltage values of all target pixels.

Optionally, the driving voltage value comprises a grayscale voltage value.

According to another embodiment of the present disclosure, a display device comprising a display panel and a driving chip is provided. The driving chip is configured to obtain a standard driving voltage value of a target pixel when a target display content is being displayed according to a standard gamma value of the display panel. The driving chip is configured to obtain a driving voltage interval and an endpoint voltage value and an endpoint mura removing parameter of each driving voltage interval. The driving chip is configured to obtain a target driving voltage interval corresponding to the standard driving voltage value. The driving chip is configured to determine an effective driving voltage value of the target pixel when the target display content is being displayed according to the standard gamma value, the standard driving voltage, and a driving voltage value of an interval endpoint and the corresponding mura removing parameter of a target driving voltage interval. The driving chip is configured to drive the display panel according to the effective driving voltage value of the target pixel.

According to still another embodiment of the present disclosure, a driving device is disclosed. The driving device comprises: a first obtaining unit, configured to obtain a standard driving voltage value of a target pixel when a target display content is being displayed according to a standard gamma value of a display panel; a second obtaining unit, configured to obtain a driving voltage interval and an endpoint voltage value and an endpoint mura removing parameter of each driving voltage interval; a third obtaining unit, configured to obtain a target driving voltage interval corresponding to the standard driving voltage value; a determination unit, configured to determine an effective driving voltage value of the target pixel when the target display content is being displayed according to the standard gamma value, the standard driving voltage, and a driving voltage value of an interval endpoint and the corresponding mura removing parameter of a target driving voltage interval; and a driving unit, configured to drive the display panel according to the effective driving voltage value of the target pixel.

Optionally, the first obtaining unit is further configured to obtain a first luminance value corresponding to the driving voltage value of the interval endpoint and a second luminance value corresponding to a test voltage value of the display panel; determine a middle gamma value corresponding to each interval endpoint according to the driving voltage value of the interval endpoint, the test voltage value, the first luminance value and the second luminance value; and determine the standard gamma value according to the middle gamma value.

Optionally, the second obtaining unit is further configured to determine a reference curve of a driving voltage and a luminance of the display panel according to the second luminance value, and to determine the endpoint mura removing parameter of each interval endpoint according to the first luminance value corresponding to each interval endpoint and the reference curve.

Optionally, the third obtaining unit is further configured to determine a reference voltage value corresponding to each interval endpoint according to the reference curve and the first luminance value corresponding to each interval endpoint; and determine the endpoint mura removing parameter corresponding to each interval endpoint according to the reference voltage value and the driving voltage value corresponding to each interval endpoint.

Optionally, the determination unit is further configured to generate an endpoint curve value corresponding to the interval endpoint according to the standard gamma value and the driving voltage value of the interval endpoint; generate a standard curve value corresponding to the standard driving voltage value according to the standard gamma value and the standard driving voltage value; and determine the effective driving voltage value according to the standard curve value, the endpoint curve value and the mura removing parameter corresponding to the interval endpoint.

Optionally, the determination unit is further configured to determine the mura removing parameter corresponding to the target driving voltage value according to the standard curve value, the endpoint curve value and the mura removing parameter corresponding to the interval endpoint; and determine the effective driving voltage value according to the mura removing parameter corresponding to the target driving voltage value and the standard driving voltage value.

Optionally, the driving unit is further configured to determine effective driving voltage values of non-target pixels according to the effective driving voltage values of all target pixels; and drive the display panel according to the effective driving voltage values of non-target pixels and the effective driving voltage values of all target pixels.

### Advantageous Effect

The present disclosure provides a display panel driving method. The display panel driving method comprises: obtaining a standard driving voltage value of a target pixel when a target display content is being displayed according to a standard gamma value of a display panel; obtaining a driving voltage interval and an endpoint voltage value and an endpoint mura removing parameter of each driving voltage interval; obtaining a target driving voltage interval corresponding to the standard driving voltage value; determining an effective driving voltage value of the target pixel when the target display content is being displayed according to the standard gamma value, the standard driving voltage, and a driving voltage value of an interval endpoint and the corresponding mura removing parameter of a target driving voltage interval; and driving the display panel according to the effective driving voltage value of the target pixel. The present disclosure could set a standard gamma value according to different display panels; determine an effective driving voltage value of a target pixel when the target display content is being displayed according to the standard gamma value, a standard driving voltage, and a driving voltage value of an interval endpoint and a corresponding mura removing parameter of a target driving voltage interval; and drive the display panel according to the effective driving voltage value of all the target pixels. This effectively alleviates the display inequality issue even if a common gamma value is applied.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a flow chart of a display panel driving method according to an embodiment of the present disclosure.

FIG. 2 is a diagram of a gamma curve according to an embodiment of the present disclosure.

FIG. 3 is a diagram of a display device according to an embodiment of the present disclosure.

FIG. 4 is a diagram of a driving device according to an embodiment of the present disclosure.

### DETAILED DESCRIPTION

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

Spatially relative terms, such as “center,” “upper,” “lower,” “left,” “right,” “vertical,” “horizontal,” “top,” “bottom,” “inner,” “outer,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. In addition, descriptions related to “first”, “second”, etc. in this disclosure are for descriptive purposes only, and cannot be understood as indicating or implying their relative importance or implicitly indicating the number of technical features indicated. Therefore, the features defined as “first” and “second” may explicitly or implicitly include at least one of the features. In the description of the present disclosure, the meaning of “a plurality” is at least two, for example, two, three, etc., unless it is specifically and specifically defined otherwise.

Any process or method described in the flowchart or otherwise described herein may be understood to include one or more modules, fragments, or portions of code of an executable instruction to implement a particular logical function or process. In addition, the scope of at least one embodiment of the present disclosure includes additional implementations in which the functions may be performed in a sequence that is not shown or discussed, including in a substantially simultaneous manner or in the reverse order depending on the function involved, which is understood by those skilled in the art to which this present disclosure pertains.

According to an embodiment of the present disclosure, a display panel driving method, a display device and a driving device are provided to alleviate the display inequality issue even if a common gamma value is applied.

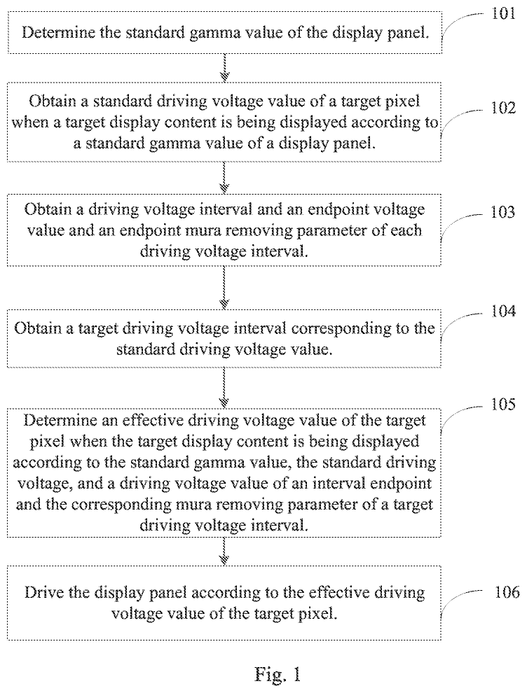

Please refer to FIG. 1. FIG. 1 is a flow chart of a display panel driving method according to an embodiment of the present disclosure. As shown in FIG. 1, the display panel driving method comprises following steps:

Step 101: Determine the standard gamma value of the display panel.

The step 101 could comprise: obtaining a first luminance value corresponding a driving voltage value of an interval endpoint and a second luminance value corresponding to a test voltage value of the display panel; determining a middle gamma value corresponding to each interval endpoint according to the driving voltage value of the interval endpoint, the test voltage value, the first luminance value and the second luminance value; and determining the standard gamma value according to the middle gamma value. Here, the interval endpoint could be an endpoint of a driving voltage interval. The driving voltage value of the interval endpoint could be a grayscale voltage value corresponding to the interval endpoint. The test voltage value could be a grayscale voltage value corresponding to a test point of the driving voltage interval. The first luminance value and the second luminance value could be luminance values obtained by the light gathering module of the display panel when the corresponding driving voltage values are applied or the luminance values calculated according to a Colorimetry equation.

In one embodiment, the following equation (1) could be used to determine the middle gamma value corresponding to each interval endpoint:

$${GM}_{n} = \frac{lg ( n / 255 )}{lg ( {lv}_{n} / {lv}_{255} )} \qquad ( 1 )$$

Here, the number n represents the gray value determined according to the driving voltage. lvₙ represents the luminance when the gray value of the pixel is n. 255 is the greatest gray value. lv₂₅₅ represents the luminance when the gray value of the pixel is 255. GMₙ represents the middle gamma value when the gray value of the display panel is n.

For example, when the gray value corresponding to the driving voltage value of the interval endpoint is 50 and the corresponding first luminance value is 0.1, the middle gamma value corresponding to the interval endpoint is 0.7.

Then, the following equation is used to calculate the standard gamma value:

GM_{M}=(GM_{A}+GM_{B}+GM_{C})/3 (2)

Here, GM_{M} is the standard gamma value. GM_{A} and GM_{B} are the middle gamma values respectively corresponding to the driving voltage values of two interval endpoints. GM_{C} is the middle gamma value corresponding to the test voltage value.

In the following embodiments, the standard gamma value of the display panel is 2.3. However, it could be understood that different display panels could have different standard gamma values instead of the same one. Therefore, the standard gamma value of 2.3 is only an example, not a limitation of the present disclosure.

Step 102: Obtain a standard driving voltage value of a target pixel when a target display content is being displayed according to a standard gamma value of a display panel.

The target display content could be an image or video content to be displayed in the display panel. The standard voltage value could be an ideal driving voltage value for driving the target pixel.

The target pixel could be M*N pixels arranged in an array in the display panel.

The driving voltage value could comprise a grayscale voltage value.

Step 103: Obtain a driving voltage interval and an endpoint voltage value and an endpoint mura removing parameter of each driving voltage interval.

The step of obtaining the mura removing parameter could comprise: determining a reference curve of the driving voltage and the luminance value of the display panel according to the second luminance value; and determining the endpoint mura removing parameter of each interval endpoint according to the first luminance value corresponding to each interval endpoint and the reference curve. Here, the reference curve could be a gamma curve corresponding to the standard gamma value of the display panel. For example, the reference curve could be a gamma curve corresponding to the standard gamma value of 2.3 of the display panel.

The step of determining the endpoint mura removing parameter of each interval endpoint according to the first luminance value corresponding to each interval endpoint and the reference curve could comprise: determining a reference voltage value corresponding to each interval endpoint according to the reference curve and the first luminance value corresponding to each interval endpoint; and determining the endpoint mura removing parameter corresponding to each interval endpoint according to the reference voltage value and the driving voltage value corresponding to each interval endpoint. Here, it should be understood that the reference voltage value and the actual driving voltage value, for driving the target pixel to have a target luminance, may have difference because of all kinds of factors, such as manufacturing variations and deterioration. For example, the reference voltage value could be an ideal driving voltage value of the interval endpoint for driving the target pixel to reach the first luminance value, where the ideal driving voltage value is calculated according to the reference curve and the first luminance value. The actual driving voltage value could be an actual driving voltage value of the interval endpoint for driving the target pixel to reach the first luminance value. The mura removing parameter of each interval endpoint could be a difference between the ideal driving voltage value and the actual driving voltage value. For example, the reference voltage value corresponding the interval endpoint is the ideal voltage value V1 for the gray value 150 and the actual voltage value for the gray value 150 is V2. In this case, the mura removing parameter of the interval endpoint could be V2-V1.

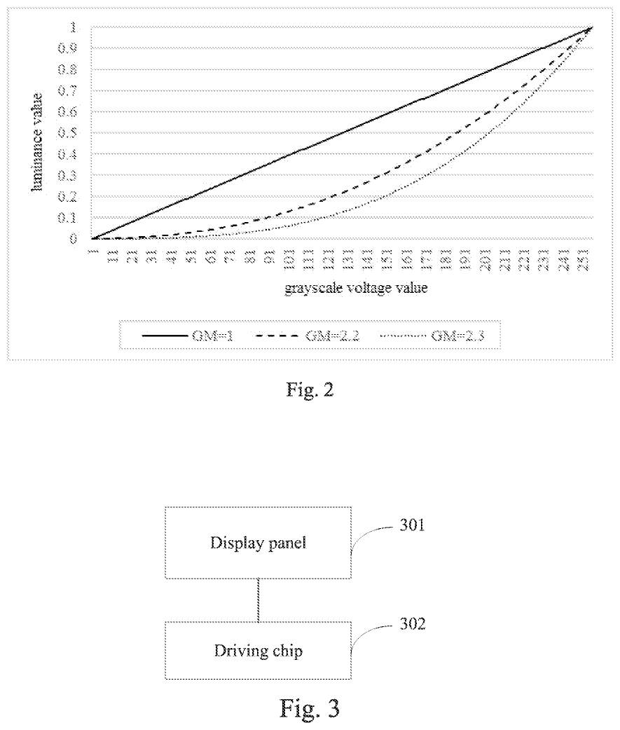

The reference curve of the driving voltage and the luminance of the display panel could be a gamma curve corresponding to the standard gamma value of the display panel. Here, the gamma curve is a curve indicating the relationship between the grayscale voltage value and the luminance value. Please refer to FIG. 2. FIG. 2 is a diagram of a gamma curve according to an embodiment of the present disclosure. The x-axis represents the grayscale value and the y-axis represents the luminance value (cd/m²). The standard gamma value (Gamma, GM) of the gamma curve of the line (—) is 1. The standard gamma value of the gamma curve of the dotted line (--) is 2.2. The standard gamma value of the gamma curve of the dotted line (_._) is 2.3. Different display panels could have different gamma curves. Here, the standard gamma corresponding to the gamma curve could be the standard gamma value calculated according to the above equation (2). Please note, the standard gamma value is calculated according to the actual implementation of the display panel and is not limited by the above example.

In one embodiment, the step of determining the corresponding luminance value according to the driving voltage value could be implemented by the following steps: obtaining the display chrominance values and luminance values of each set of red sub-pixels, green sub-pixels and blue sub-pixels when the input driving voltage value is x; obtaining a target white chrominance value and a target white luminance value; and calculating the target luminance values of each set of red sub-pixels, green sub-pixels and blue sub-pixels when the input driving voltage value is x according to the Colorimetry equation.

A red sub-pixel, a blue sub-pixel and a green sub-pixel could constitute a set of sub-pixels (a pixel).

Step 104: Obtain a target driving voltage interval corresponding to the standard driving voltage value.

In an embodiment, the target driving voltage interval could be a driving voltage interval comprising the standard driving voltage value.

Step 105: Determine an effective driving voltage value of the target pixel when the target display content is being displayed according to the standard gamma value, the standard driving voltage, and a driving voltage value of an interval endpoint and the corresponding mura removing parameter of a target driving voltage interval.

In an embodiment, the Step 105 comprises: generating an endpoint curve value corresponding to the interval endpoint according to the standard gamma value and the driving voltage value of the interval endpoint; generating a standard curve value corresponding to the standard driving voltage value according to the standard gamma value and the standard driving voltage value; and determining the effective driving voltage value according to the standard curve value, the endpoint curve value and the mura removing parameter corresponding to the interval endpoint. Here, the endpoint curve value could be a curve value corresponding to the driving voltage value of the interval endpoint calculated according to the gamma curve corresponding to the standard gamma value. The standard curve value could be a curve value corresponding to the standard driving voltage value calculated according to the gamma curve corresponding to the standard gamma value.

Specifically, the following equation (3) could be used to calculate the endpoint curve value or the standard curve value:

Curveₙ=(n/255)^{GM} (3)

Here, the number n represents the gray value determined according to the driving voltage value. GM represents the standard gamma value. Curveₙ represents the curve value when the gray value is n.

For example, under the condition that the standard gamma value GM=2.3, the curve value Curve₁₂₈ when the gray value is 128, determined according to the driving voltage value, is 0.204899.

In an embodiment, the step of determining the effective driving voltage value according to the standard curve value, the endpoint curve value and the mura removing parameter corresponding to the interval endpoint could comprise: determining the mura removing parameter corresponding to the target driving voltage value according to the standard curve value, the endpoint curve value and the mura removing parameter corresponding to the interval endpoint; and determining the effective driving voltage value according to the mura removing parameter corresponding to the target driving voltage value and the standard driving voltage value. Here, the effective driving voltage value could be an actual driving voltage value after the target pixel is processed with a mura removing process. The mura removing parameter corresponding to the interval endpoint could be an endpoint mura removing parameter. The mura removing parameter corresponding to the standard driving voltage value could be the difference between the standard driving voltage value and the actual driving voltage value corresponding to the target pixel.

The following equation (4) could be used to determine the mura removing parameter corresponding to the standard driving voltage:

$${Demura}_{n} = ( {Demura}_{B} - {Demura}_{A} ) * \frac{{Curve}_{n} - {Curve}_{A}}{{Curve}_{B} - {Curve}_{A}} + {Demura}_{A} \qquad ( 4 )$$

Here, Demuraₙ represents the mura parameter corresponding to the standard driving voltage value. Curve_{A} and Curve_{B} respectively represent the endpoint curve values of two interval endpoints. Curveₙ represents the standard curve value corresponding to the standard driving voltage value. Demura_{A} and Demura_{B} respectively represent the mura removing parameters corresponding to the two interval endpoints.

For example, the standard driving voltage is the driving voltage value V3 corresponding to the gray value 100. The mura removing parameter corresponding to the standard driving voltage is V4. Then, the effective driving voltage value for the target pixel to display the target display content could be V3+V4.

Step 106: Drive the display panel according to the effective driving voltage value of the target pixel.

The Step 106 could comprise: determining effective driving voltage values of non-target pixels according to the effective driving voltage values of all target pixels; and driving the display panel according to the effective driving voltage values of non-target pixels and the effective driving voltage values of all target pixels.

The target pixels could be those pixels having the related data, such as the effective driving voltages, which had been inputted and stored in the display panel. The non-target pixels could be those pixels, where the related data, such as the effective driving voltages, which had not been inputted and stored in the display panel. Here, the driving voltage input plate could be the timing controller (TCON) plate electrically connected to the display panel. The driving voltage input plate could store the driving voltage table. The driving voltage table stores the effective driving voltage values corresponding to the target pixels. In this way, when the display panel works, the effective driving voltages could be determined by looking up the driving voltage table and inputted to the display panel to drive the target pixels. For the non-target pixels, the effective driving voltages of the non-target pixels could be determined according to the determination method of the effective driving voltages of the target pixels. The two mechanisms work together such that the entire display panel could work.

The present disclosure provides a display panel driving method. The present disclosure could obtain a standard driving voltage value of a target pixel when a target display content is being displayed according to a standard gamma value of a display panel; obtain a driving voltage interval and an endpoint voltage value and an endpoint mura removing parameter of each driving voltage interval; obtain a target driving voltage interval corresponding to the standard driving voltage value; determine an effective driving voltage value of the target pixel when the target display content is being displayed according to the standard gamma value, the standard driving voltage, and a driving voltage value of an interval endpoint and the corresponding mura removing parameter of a target driving voltage interval; and drive the display panel according to the effective driving voltage value of the target pixel. This method could set a standard gamma value according to different display panels; determine an effective driving voltage value of a target pixel when the target display content is being displayed according to the standard gamma value, a standard driving voltage, and a driving voltage value of an interval endpoint and a corresponding mura removing parameter of a target driving voltage interval; and drive the display panel according to the effective driving voltage value of all the target pixels. This effectively alleviates the display inequality issue even if a common gamma value is applied.

Please refer to FIG. 3. FIG. 3 is a diagram of a display device according to an embodiment of the present disclosure. As shown in FIG. 3, a display device is disclosed. The display device comprises a display panel 301 and a driving chip 302.

The display panel 301 comprises a plurality of pixels. The driving chip 302 is configured to obtain a standard driving voltage value of a target pixel when a target display content is being displayed according to a standard gamma value of a display panel. The driving chip 302 is configured to obtain a driving voltage interval and an endpoint voltage value and an endpoint mura removing parameter of each driving voltage interval. The driving chip 302 is configured to obtain a target driving voltage interval corresponding to the standard driving voltage value. The driving chip 302 is configured to determine an effective driving voltage value of the target pixel when the target display content is being displayed according to the standard gamma value, the standard driving voltage, and a driving voltage value of an interval endpoint and the corresponding mura removing parameter of a target driving voltage interval. The driving chip 302 is configured to drive the display panel according to the effective driving voltage value of the target pixel.

Optionally, the driving chip 302 is configured to generate an endpoint curve value corresponding to the interval endpoint according to the standard gamma value and the driving voltage value of the interval endpoint. The driving chip 302 is configured to generate a standard curve value corresponding to the standard driving voltage value according to the standard gamma value and the standard driving voltage value. The driving chip 302 is configured to determine the effective driving voltage value according to the standard curve value, the endpoint curve value and the mura removing parameter corresponding to the interval endpoint.

Optionally, the driving chip 302 is configured to determine the mura removing parameter corresponding to the target driving voltage value according to the standard curve value, the endpoint curve value and the mura removing parameter corresponding to the interval endpoint. The driving chip 302 is configured to determine the effective driving voltage value according to the mura removing parameter corresponding to the target driving voltage value and the standard driving voltage value.

Optionally, the driving chip 302 is configured to obtain a first luminance value corresponding to the driving voltage value of the interval endpoint and a second luminance value corresponding to a test voltage value of the display panel. The driving chip 302 is configured to determine a middle gamma value corresponding to each interval endpoint according to the driving voltage value of the interval endpoint, the test voltage value, the first luminance value and the second luminance value. The driving chip 302 is configured to determine the standard gamma value according to the middle gamma value.

Optionally, the driving chip 302 is configured to determine a reference curve of a driving voltage and a luminance of the display panel according to the second luminance value. The driving chip 302 is configured to determine the endpoint mura removing parameter of each interval endpoint according to the first luminance value corresponding to each interval endpoint and the reference curve.

Optionally, the driving chip 302 is configured to determine a reference voltage value corresponding to each interval endpoint according to the reference curve and the first luminance value corresponding to each interval endpoint. The driving chip 302 is configured to determine the endpoint mura removing parameter corresponding to each interval endpoint according to the reference voltage value and the driving voltage value corresponding to each interval endpoint.

Optionally, the driving chip 302 is configured to determine effective driving voltage values of non-target pixels according to the effective driving voltage values of all target pixels. The driving chip 302 is configured to drive the display panel according to the effective driving voltage values of non-target pixels and the effective driving voltage values of all target pixels.

Optionally, the display panel could further comprise a luminance obtaining module and a storage device. The luminance obtaining module is configured to obtain the luminance of the pixel of the display panel. The storage device is configured to store the programs required for the driving chip to perform its function.

The storage device could be a flash memory to have a better operating speed.

The luminance obtaining module comprises a camera, such as a charged-coupled device (CCD) camera to obtain a display image of the OLED display panel. The CCD camera could obtain the display luminance of each sub-pixel and thus raise the accuracy of luminance adjustment.

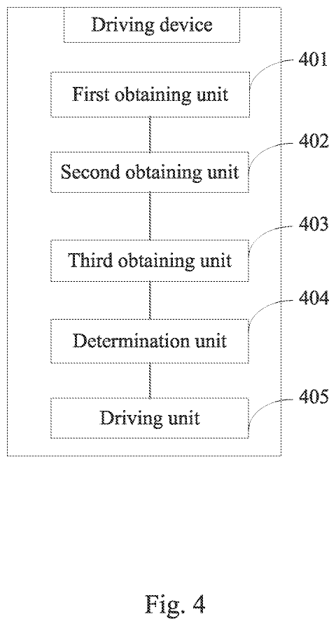

Please refer to FIG. 4. FIG. 4 is a diagram of a driving device according to an embodiment of the present disclosure. As shown in FIG. 4, a driving device is disclosed. The driving device comprises a first obtaining unit 401, a second obtaining unit 402, a third obtaining unit 403, a determination unit 404 and a driving unit 405.

The first obtaining unit 401 is configured to obtain a standard driving voltage value of a target pixel when a target display content is being displayed according to a standard gamma value of a display panel.

The second obtaining unit 402 is configured to obtain a driving voltage interval and an endpoint voltage value and an endpoint mura removing parameter of each driving voltage interval.

The third obtaining unit 403 is configured to obtain a target driving voltage interval corresponding to the standard driving voltage value.

The determination unit 404 is configured to determine an effective driving voltage value of the target pixel when the target display content is being displayed according to the standard gamma value, the standard driving voltage, and a driving voltage value of an interval endpoint and the corresponding mura removing parameter of a target driving voltage interval.

The driving unit 405 is configured to drive the display panel according to the effective driving voltage value of the target pixel.

Optionally, the first obtaining unit 401 is further configured to obtain a first luminance value corresponding to the driving voltage value of the interval endpoint and a second luminance value corresponding to a test voltage value of the display panel; determine a middle gamma value corresponding to each interval endpoint according to the driving voltage value of the interval endpoint, the test voltage value, the first luminance value and the second luminance value; and determine the standard gamma value according to the middle gamma value.

Optionally, the second obtaining unit 402 is further configured to determine a reference curve of a driving voltage and a luminance of the display panel according to the second luminance value; and determine the endpoint mura removing parameter of each interval endpoint according to the first luminance value corresponding to each interval endpoint and the reference curve.

Optionally, the third obtaining unit 403 is further configured to determine a reference voltage value corresponding to each interval endpoint according to the reference curve and the first luminance value corresponding to each interval endpoint; and determine the endpoint mura removing parameter corresponding to each interval endpoint according to the reference voltage value and the driving voltage value corresponding to each interval endpoint.

Optionally, the determination unit 404 is further configured to generate an endpoint curve value corresponding to the interval endpoint according to the standard gamma value and the driving voltage value of the interval endpoint; generate a standard curve value corresponding to the standard driving voltage value according to the standard gamma value and the standard driving voltage value; and determine the effective driving voltage value according to the standard curve value, the endpoint curve value and the mura removing parameter corresponding to the interval endpoint.

Optionally, the determination unit 404 is further configured to determine the mura removing parameter corresponding to the target driving voltage value according to the standard curve value, the endpoint curve value and the mura removing parameter corresponding to the interval endpoint; and determine the effective driving voltage value according to the mura removing parameter corresponding to the target driving voltage value and the standard driving voltage value.

Optionally, the driving unit 405 is further configured to determine effective driving voltage values of non-target pixels according to the effective driving voltage values of all target pixels; and drive the display panel according to the effective driving voltage values of non-target pixels and the effective driving voltage values of all target pixels.

While the embodiments of the present disclosure have been shown and described above, it is to be understood that the above embodiments are exemplary and are not to be construed as limiting the present disclosure. One of ordinary skill in the art may make variations, modifications, substitutions and alterations to the above embodiments within the scope of the present disclosure.

Above are embodiments of the present disclosure, which does not limit the scope of the present disclosure. Any modifications, equivalent replacements or improvements within the spirit and principles of the embodiment described above should be covered by the protected scope of the disclosure.

1. A display panel driving method, comprising:
obtaining a standard driving voltage value of a target pixel when a target display content is being displayed according to a standard gamma value of a display panel;
obtaining a driving voltage interval and an endpoint voltage value and an endpoint mura removing parameter of each driving voltage interval;
obtaining a target driving voltage interval corresponding to the standard driving voltage value;
determining an effective driving voltage value of the target pixel when the target display content is being displayed according to the standard gamma value, the standard driving voltage, and a driving voltage value of an interval endpoint and the corresponding mura removing parameter of a target driving voltage interval; and
driving the display panel according to the effective driving voltage value of the target pixel.

2. The display panel driving method of claim 1, wherein the step of determining an effective driving voltage value of the target pixel when the target display content is being displayed according to the standard gamma value, the standard driving voltage, and the driving voltage value of the interval endpoint and the corresponding mura removing parameter of the target driving voltage interval comprises:
generating an endpoint curve value corresponding to the interval endpoint according to the standard gamma value and the driving voltage value of the interval endpoint;
generating a standard curve value corresponding to the standard driving voltage value according to the standard gamma value and the standard driving voltage value; and
determining the effective driving voltage value according to the standard curve value, the endpoint curve value and the mura removing parameter corresponding to the interval endpoint.

3. The display panel driving method of claim 2, wherein the step of determining the effective driving voltage value according to the standard curve value, the endpoint curve value and the mura removing parameter corresponding to the interval endpoint comprises:
determining the mura removing parameter corresponding to the target driving voltage value according to the standard curve value, the endpoint curve value and the mura removing parameter corresponding to the interval endpoint; and
determining the effective driving voltage value according to the mura removing parameter corresponding to the target driving voltage value and the standard driving voltage value.

4. The display panel driving method of claim 1, wherein the step of obtaining the standard gamma value comprises:
obtaining a first luminance value corresponding to the driving voltage value of the interval endpoint and a second luminance value corresponding to a test voltage value of the display panel;
determining a middle gamma value corresponding to each interval endpoint according to the driving voltage value of the interval endpoint, the test voltage value, the first luminance value and the second luminance value; and
determining the standard gamma value according to the middle gamma value.

5. The display panel driving method of claim 4, wherein the step of obtaining the endpoint mura removing parameter comprises:
determining a reference curve of a driving voltage and a luminance of the display panel according to the second luminance value; and
determining the endpoint mura removing parameter of each interval endpoint according to the first luminance value corresponding to each interval endpoint and the reference curve.

6. The display panel driving method of claim 5, wherein the step of determining the endpoint mura removing parameter of each interval endpoint according to the first luminance value corresponding to each interval endpoint and the reference curve comprises:
determining a reference voltage value corresponding to each interval endpoint according to the reference curve and the first luminance value corresponding to each interval endpoint; and
determining the endpoint mura removing parameter corresponding to each interval endpoint according to the reference voltage value and the driving voltage value corresponding to each interval endpoint.

7. The display panel driving method of claim 5, wherein the step of determining the reference curve of the driving voltage and the luminance of the display panel according to the second luminance value comprises:
obtaining a predetermined corresponding relationship between the driving voltage value and the luminance value;
obtaining the second luminance value; and
determining the reference curve of the driving voltage and the luminance of the display panel according to the second luminance value and the predetermined corresponding relationship between the driving voltage value and the luminance value.

8. The display panel driving method of claim 1, wherein the step of driving the display panel according to the effective driving voltage value of the target pixel comprises:
determining effective driving voltage values of non-target pixels according to the effective driving voltage values of all target pixels; and
driving the display panel according to the effective driving voltage values of non-target pixels and the effective driving voltage values of all target pixels.

9. The display panel driving method of claim 1, wherein the driving voltage value comprises a grayscale voltage value.

10. A display panel driving method, comprising:
obtaining a standard driving voltage value of a target pixel when a target display content is being displayed according to a standard gamma value of a display panel;
obtaining a driving voltage interval and an endpoint voltage value and an endpoint mura removing parameter of each driving voltage interval;
obtaining a target driving voltage interval corresponding to the standard driving voltage value;
generating an endpoint curve value corresponding to the interval endpoint according to the standard gamma value and the driving voltage value of the interval endpoint;
generating a standard curve value corresponding to the standard driving voltage value according to the standard gamma value and the standard driving voltage value;
determining effective driving voltage values of non-target pixels according to the effective driving voltage values of all target pixels; and
driving the display panel according to the effective driving voltage values of non-target pixels and the effective driving voltage values of all target pixels.

11. The display panel driving method of claim 10, wherein the step of determining the effective driving voltage value according to the standard curve value, the endpoint curve value and the mura removing parameter corresponding to the interval endpoint comprises:
determining the mura removing parameter corresponding to the target driving voltage value according to the standard curve value, the endpoint curve value and the mura removing parameter corresponding to the interval endpoint; and
determining the effective driving voltage value according to the mura removing parameter corresponding to the target driving voltage value and the standard driving voltage value.

12. The display panel driving method of claim 10, wherein the step of obtaining the standard gamma value comprises:
obtaining a first luminance value corresponding to the driving voltage value of the interval endpoint and a second luminance value corresponding to a test voltage value of the display panel;
determining a middle gamma value corresponding to each interval endpoint according to the driving voltage value of the interval endpoint, the test voltage value, the first luminance value and the second luminance value; and
determining the standard gamma value according to the middle gamma value.

13. (canceled)

14. A driving device, comprising:
a first obtaining unit, configured to obtain a standard driving voltage value of a target pixel when a target display content is being displayed according to a standard gamma value of a display panel;
a second obtaining unit, configured to obtain a driving voltage interval and an endpoint voltage value and an endpoint mura removing parameter of each driving voltage interval;
a third obtaining unit, configured to obtain a target driving voltage interval corresponding to the standard driving voltage value;
a determination unit, configured to determine an effective driving voltage value of the target pixel when the target display content is being displayed according to the standard gamma value, the standard driving voltage, and a driving voltage value of an interval endpoint and the corresponding mura removing parameter of a target driving voltage interval; and
a driving unit, configured to drive the display panel according to the effective driving voltage value of the target pixel.

15. The driving device of claim 14, wherein the first obtaining unit is configured to:
obtain a first luminance value corresponding to the driving voltage value of the interval endpoint and a second luminance value corresponding to a test voltage value of the display panel;
determine a middle gamma value corresponding to each interval endpoint according to the driving voltage value of the interval endpoint, the test voltage value, the first luminance value and the second luminance value; and
determine the standard gamma value according to the middle gamma value.

16. The driving device of claim 14, wherein the second obtaining unit is configured to:
determine a reference curve of a driving voltage and a luminance of the display panel according to the second luminance value; and
determine the endpoint mura removing parameter of each interval endpoint according to the first luminance value corresponding to each interval endpoint and the reference curve.

17. The driving device of claim 14, wherein the second obtaining unit is further configured to:
determine a reference voltage value corresponding to each interval endpoint according to the reference curve and the first luminance value corresponding to each interval endpoint; and
determine the endpoint mura removing parameter corresponding to each interval endpoint according to the reference voltage value and the driving voltage value corresponding to each interval endpoint.

18. The driving device of claim 14, wherein the determination unit is further configured to:
generate an endpoint curve value corresponding to the interval endpoint according to the standard gamma value and the driving voltage value of the interval endpoint;
generate a standard curve value corresponding to the standard driving voltage value according to the standard gamma value and the standard driving voltage value; and
determine the effective driving voltage value according to the standard curve value, the endpoint curve value and the mura removing parameter corresponding to the interval endpoint.

19. The driving device of claim 14, wherein the determination unit is further configured to:
determine the mura removing parameter corresponding to the target driving voltage value according to the standard curve value, the endpoint curve value and the mura removing parameter corresponding to the interval endpoint; and
determine the effective driving voltage value according to the mura removing parameter corresponding to the target driving voltage value and the standard driving voltage value.

20. The driving device of claim 14, wherein the determination unit is configured to:
determine effective driving voltage values of non-target pixels according to the effective driving voltage values of all target pixels; and
drive the display panel according to the effective driving voltage values of non-target pixels and the effective driving voltage values of all target pixels.
